(19) United States
(12) Patent Application Publication
(10) Pub. No.: US 2023/0059425 A1
(43) Pub. Date: Feb. 23, 2023

(54) NAVIGATION SYSTEM AND NAVIGATION METHOD IMPLEMENTED THEREBY

(71) Applicant: Old Cookies Co., Ltd., Taipei City (TW)

(72) Inventors: Shih-Chiun HONG, Taipei City (TW); Jih-Cherng Dennis CHEN, Taipei City (TW)

(21) Appl. No.: 17/872,946

(22) Filed: Jul. 25, 2022

(30) Foreign Application Priority Data
Aug. 23, 2021 (TW) 110131036

(51) Int. Cl. G01C 21/34; G06V 20/58

(52) U.S. Cl. CPC G01C 21/3415; G06V 20/582

(57) ABSTRACT

A navigation system includes a processing unit connected to a storage device for fetching and executing a navigation program to: determine a planned route; obtain a real-time image and real-time positioning data indicating a current location of the system; perform image recognition on the image, and determine whether a specific object exists in the image; determine whether a route adjustment condition is met based on the planned route, the positioning data and result of the determination; and adjust the planned route when the route adjustment condition is met. The route adjustment condition includes that a meaning conveyed by the specific object is in conflict with the planned route.

### CROSS-REFERENCE TO RELATED APPLICATION

This application claims priority to Taiwanese Invention Patent Application No. 110131036, filed on Aug. 23, 2021.

### FIELD

The disclosure relates to a navigation system, in particular to a navigation system suitable for application to a vehicle. The disclosure further relates to a navigation method implemented by said navigation system.

### BACKGROUND

In modern society, the driver of a vehicle usually utilizes a navigation system to provide assistance when driving. However, when there are unexpected road conditions, the existing navigation products cannot process the unexpected road conditions, so the driver needs to handle them by himself/herself. Thus, there is still room for improvement over the prior art.

### SUMMARY

Therefore, an object of the present disclosure is to improve upon the existing technology by providing a navigation system that is capable of responding to road conditions in real time.

According to one aspect of this disclosure, a navigation system is adapted to be installed on a vehicle, and includes a storage device storing a navigation program and a processing unit electrically connected to the storage device for fetching and executing the navigation program to perform the following:
determine a planned route;
obtain a real-time image and real-time positioning data that indicates a current location of the navigation system;
perform image recognition on the real-time image, and determine whether a specific object exists in the real-time image;
determine whether a route adjustment condition is met based on the planned route, the real-time positioning data and result of the determination on whether the specific object exists in the real-time image; and
adjust the planned route when the route adjustment condition is met.

The route adjustment condition includes that a meaning conveyed by the specific object is in conflict with the planned route.

Another object of this disclosure is to provide a navigation method implemented by said navigation system.

According to another aspect of this disclosure, a navigation method is to be implemented by a navigation system adapted to be disposed on a vehicle and includes the following steps:
determining a planned route;
obtaining a real-time image and real-time positioning data that indicates a current location of the navigation system;
performing image recognition on the real-time image, and determining whether a specific object exists in the real-time image;
determining whether a route adjustment condition is met based on the planned route, the positioning data and a result of the determination on whether the specific object exists in the real-time image; and
when the route adjustment condition is met, adjusting the planned route.

The route adjustment condition includes that there is a conflict between the specific object and the planned route.

### BRIEF DESCRIPTION OF THE DRAWINGS

Other features and advantages of the disclosure will become apparent in the following detailed description of the embodiment(s) with reference to the accompanying drawings, of which:

FIG. 1 is a block diagram of an embodiment of a navigation system of the present disclosure applied to a vehicle; and

FIG. 2 is a flow chart for exemplarily illustrating how the embodiment implements a navigation method.

### DETAILED DESCRIPTION

It should be noted before the present disclosure is described in detail that when not specifically defined, the term “electrical connection” as used in this specification can refer to a “wired electrical connection” implemented through conductive materials among a plurality of electronic equipment/devices/elements, as well as “wireless connections” for one-way/two-way wireless signal transmission through wireless communication technologies. Moreover, when not specifically defined, the term “electrical connection” as used in this specification can also refer to a “direct electrical connection,” formed among a plurality of electronic equipment/devices/elements that are directly connected to one another, and “indirect electrical connection,” formed among a plurality of electronic equipment/devices/elements that are indirectly connected to one another through other electronic equipment/devices/elements.

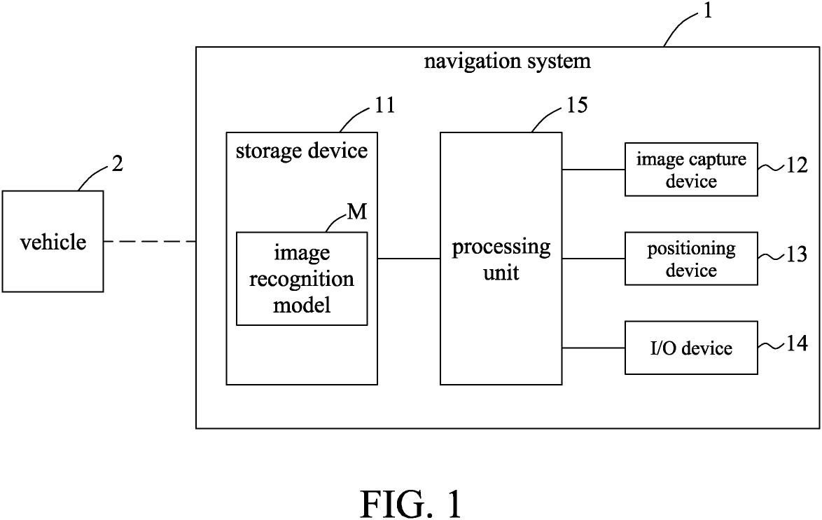

Referring to FIG. 1, an embodiment of a navigation system 1 of the present disclosure is, for example, adapted to be installed on a vehicle 2, and includes, for example, a storage device 11, an image capture device 12, a positioning device 13, an input/output (I/O) device 14, and a processing unit 15 electrically connected to the storage device 11, the image capture device 12, the positioning device 13 and the I/O device 14.

In this embodiment, the navigation system 1 is manufactured and sold independently, and is added to the vehicle 2 after the vehicle 2 leaves the factory. However, in other embodiments, the navigation system 1 may also be built-in to the vehicle 2, for example, before the vehicle 2 leaves the factory. Therefore, the actual implementation of the navigation system 1 is not limited to the present embodiment. In addition, the navigation system 1 can be applied to a general vehicle operated by a human, as well as an autonomous vehicle, an unmanned vehicle, or an aircraft that does not require human operation.

The storage device 11 may, in this embodiment, be embodied as a memory module for storing digital data. However, in other embodiments, the storage device 11 may be implemented, for example, as a conventional hard disk, a solid state disk, or other types of computer readable media, or a combination of multiple different types of computer readable medium, and is not limited to this embodiment. The storage device 11 stores a navigation program having instructions that relate to determining whether to adjust a navigation route, and allows the processing unit 15 to perform the navigation method of the present disclosure by fetching and executing the instructions.

The image capture device 12 in this embodiment may be, for example, implemented as a camera including a lens unit and an image sensor, and is adapted to be installed to face forward from the perspective of the vehicle 2 to perform continuous image capturing to generate a plurality of images, but is not limited thereto. It is worth mentioning that, although the image capture device 12 is part of the navigation system 1 in this embodiment, in other embodiments, the image capture device 12 may be an external device not belonging to the navigation system 1.

In this embodiment, the storage device 11 further includes an image recognition model (M). Specifically in this embodiment, the image recognition model (M) is a trained neural network that can be loaded and operated by the processing unit 15 to identify specific preset objects in the input images. The image recognition model (M) is trained by machine learning techniques using, for example, pre-collected pictures of specific objects, but is not limited thereto. By operating the image recognition model (M), the processing unit 15 of the embodiment is able to perform image recognition on the images and identify specific objects, such as traffic signs (e.g., prohibitory signs, traffic control signs), someone (e.g., a person, a manikin, or something resembling a person) wearing high-visibility clothing (e.g., a reflective vest or jacket), holding a traffic command object (e.g., a traffic wand or a flag) and making a specific gesture (e.g., specific movements to direct vehicles to make a left turn), roadblocks, barricades, traffic cones, or road-closed signs, but not limited thereto. In other embodiments, the image recognition model (M) is stored in a cloud server (not shown), and the processing unit 15 inputs the images to the image recognition model (M) for image recognition.

The positioning device 13 in this embodiment may be, for example, a satellite positioning module that is implemented based on satellite positioning technology. The positioning device 13 is, for example, capable of receiving satellite signals so as to determine the current location of the positioning device 13 in real-time. Specifically, in this embodiment, the satellite signals may be, for example, from Global Positioning System (abbreviated as GPS). However, in other embodiments, the satellite signals may also be from other satellite navigation systems that provide a real-time positioning function, referred to as Global Navigation Satellite Systems (abbreviated as GNSS’s), such as BeiDou Navigation Satellite System (BDS), Galileo and GLONASS, etc. Therefore, the actual implementation of the positioning device 13 is not limited to this embodiment.

The I/O device 14 in this embodiment may include, for example, one or more of a display screen, a set of buttons, a set of indicating lights and a speaker, and the display screen may be, for example, a touch display screen, but is not limited thereto.

The processing unit 15 in this embodiment may be, for example, embodied as a central processing unit (CPU). However, in other embodiments, the processing unit 15 may be, for example, implemented as a plurality of CPUs electrically connected to one another, or a control circuit board including a CPU, and implementation of the processing unit 15 is not limited to this embodiment.

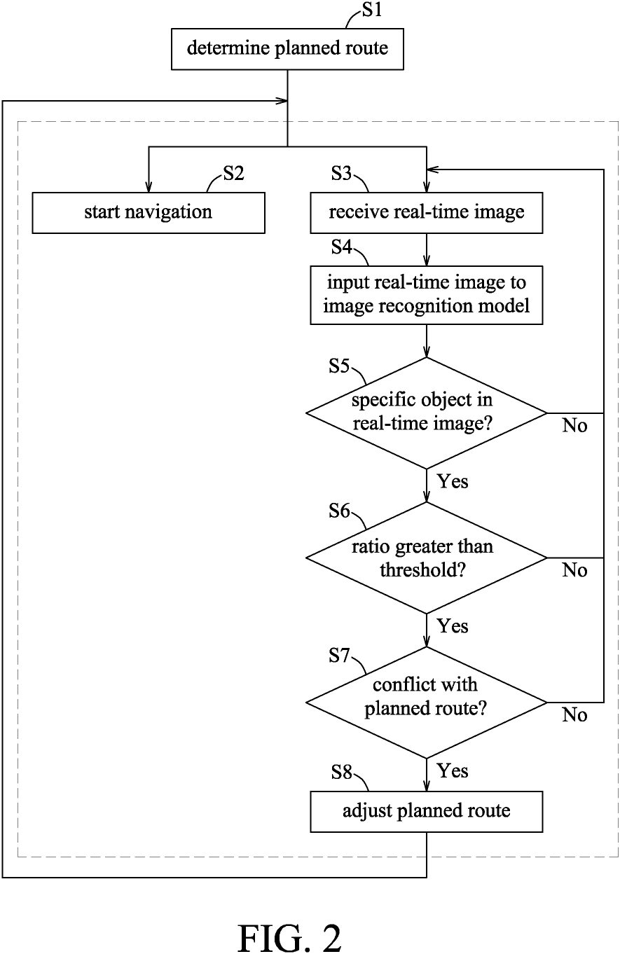

Referring to FIG. 1 and FIG. 2 at the same time, how the navigation system 1 of the present embodiment implements a navigation method will be exemplarily described in detail below.

First, in step S1, the processing unit 15 determines a planned route based on input by a user through the I/O device 14, wherein the planned route is used to guide a user to move the vehicle 2 from a current location to a destination.

In step S2, the processing unit 15 starts to navigate according to the planned route. At this time, the positioning device 13 is controlled by the processing unit 15 to continuously position and provide, in real time, positioning data (e.g., location coordinates) indicating the current location of the navigation system 1 (which is equivalent to the current location of the vehicle 2). The processing unit 15 outputs the positioning data together with the planned route through the I/O device 14, so as to provide routing cues to the driver.

In this embodiment, while the processing unit 15 is conducting navigation, the processing unit 15 activates the image capture device 12 to continuously perform image capturing, thereby obtaining a plurality of images of real-time updates (hereinafter referred to as real-time images) from the image capture device 12. Upon receipt of each real-time image (step S3), the processing unit 15 inputs the real-time image to the image recognition model (M), so that the image recognition model (M) performs image recognition on the real-time image to obtain an image recognition result. The image recognition result may include, for each of the specific objects, a score indicating the probability of the specific object (e.g., a prohibitory sign) being present in the real-time image (step S4). Then, based on the image recognition result, the processing unit 15 determines whether any of the specific objects, such as the aforementioned prohibitory sign, someone wearing high-visibility clothing, holding a traffic control object and making a specific gesture, the roadblock, the barricade, etc., exists in the real-time image, and identifies each specific object, if any, existing in the real-time image (step S5). For example, with respect to each of the specific objects, the processing unit 15 may determine that the specific object exists in the real-time image when the relevant score is greater than or equal to a predefined threshold, e.g., 80%. In some embodiments, the image recognition model (M) is able to perform object localization alongside object detection so that multiple specific objects and their respective locations within the real-time image may be identified and outputted by the image recognition model (M), so steps S4 and S5 are both performed by the processing unit 15 operating the image recognition model (M). If step S5 reveals that there is at least one specific object in the real-time image, with respect to each specific object thus identified in the real-time image, the processing unit 15 calculates a ratio of a pixel count of the specific object in the real-time image to a total pixel count of the whole real-time image, and determines whether the ratio is greater than a predetermined threshold (for example, 5%, but not limited thereto) (step S6). If the determination of step S6 is affirmative, step S7 is performed to interpret whether a meaning conveyed by the specific object is in conflict with the planned route currently being navigated. Step S8 is performed when it is determined in step S7 that a conflict exists.

In this embodiment, in step S7, the processing unit 15 determines whether the meaning conveyed by the specific object is in conflict with the currently navigated planned route by integrating the result of step S5 (namely, the presence of, for example, a traffic cone, a roadblock or a road-closed sign, and its location) with the planned route. As an example, if a road-closed sign is recognized in the real-time image and the road-closed sign is for closing a road on the path of the planned route, then it is determined in step S7 that a conflict exists; on the other hand, if the road-closed sign is for closing a road not on the path of the planned route, then no conflict exists. Detailed examples are given below.

Overall, by means of steps S3 to S7, the processing unit 15 determines whether “a condition calling for adjustments to be made to the planned route” (hereinafter referred to as “the route adjustment condition”) is met, based on the real-time image, the planned route and the positioning data. If the route adjustment condition is met, step S8 is performed. On the other hand, if the result of determination in any of steps S5, S6 and S7 is in the negative, which means that the route adjustment condition is not met, then the processing of this particular real-time image terminates and the flow returns to step S3 to process the next real-time image.

As an example, if the planned route guides the vehicle 2 to continue moving straight ahead, when the processing unit 15 determines in step S5 that the real-time image contains the specific object of a road-closed sign that is placed horizontally to the straight-ahead direction, the processing unit 15 will determine in step S7 that the meaning conveyed by the specific object is in conflict with the navigation direction of “straight ahead”, that is, the route adjustment condition is met. On the contrary, if the road-closed sign blocks the “left-turn” path, i.e., making a “left-turn” is prohibited, the processing unit 15, in step S7, will determine that the meaning conveyed by the specific object does not conflict with the planned route being navigated, i.e., the route adjustment condition is not met.

Under some situations, the specific object does not directly specify the direction of restricted access, and thus, in this embodiment, the processing unit 15 further interprets the specific object to find out whether there is one or more underlying directions of restricted access behind the meaning conveyed by the specific object in such situation.

For example, assuming that the specific object is a “detour with right arrow” traffic control sign, the processing unit 15, in step S7, will regard any direction different from a “right turn” as prohibited, and compare this restriction with the planned route that is currently being navigated. For example, at crossroads, when the processing unit 15 determines that the specific object is a “detour with right arrow” sign in step S5, the processing unit 15 will interpret “straight ahead” and “left turn” directions as prohibited and check them against the planned route currently being navigated in step S7 so as to determine whether a conflict exists. As another example, if the specific object is a traffic officer located in front of the vehicle 2, wearing a reflective vest and holding a traffic wand, and the traffic officer is using particular gestures to guide vehicles to make left turns, then the processing unit 15, in step S7, will interpret “straight ahead” and “right turn” as the directions of restricted access conveyed by the specific object, and check them against the planned route currently being navigated to determine whether there is a conflict.

In other words, in an embodiment of the present disclosure, if a specific object identified in the real-time image indicates restricted access in certain direction(s), and such direction(s) is in conflict with the planned route, the processing unit 15 will adjust the planned route based on the positioning data, the planned route, and the direction(s) of restricted access conveyed by the specific object. In more detail, the processing unit 15 adjusts the planned route by excluding the original planned route and the direction(s) of restricted access from the route planning. For example, in step S8, an original forward-moving route may be adjusted to direct the driver to make a right turn first, and then the adjusted (updated) planned route following the right turn will be computed by the processing unit 15 based on known route planning techniques and then displayed on the I/O device 14 for the driver’s reference.

The advantages of the present embodiment reside in that the navigation system 1 is able to determine whether an upcoming path segment of a predetermined navigation route (planned route) has restricted access, and immediately adjust the planned route in the affirmative. Thus, the navigation system 1 is able to provide better driving assistance with real-time responses to unexpected situations that may occur during actual driving.

The above is an example illustrating how the navigation system 1 of the present embodiment implements the navigation method. It should be understood that steps S1 to S8 described above and the flow chart shown in FIG. 2 are merely to illustrate one way of implementing the navigation method, and implementations with steps S1 to S8 being merged, divided or adjusted in terms of order of execution still belong to the present disclosure, as long as they can achieve the same effect as the described embodiment. Therefore, the discussed embodiment is not intended to limit the practicable range of the present disclosure.

In summary, the navigation system 1 is able to perform image recognition on the real-time images to identify a variety of specific objects, and, when the navigation system 1 determines that the route adjustment condition is met, the navigation system 1 will adjust the planned route in real time based on the direction(s) of restricted access indicated by the identified specific object, in order to deal with unexpected actual road conditions immediately. In this way, when a temporary closure or prohibition occurs on the original planned route, the navigation system 1 will automatically and immediately plan a new navigation route, and provide better assistance to the driver. Therefore, the object of the present disclosure can indeed be achieved.

What is claimed is:

1. A navigation system adapted to be installed on a vehicle, the navigation system comprising:
a storage device storing a navigation program; and
a processing unit electrically connected to the storage device for fetching and executing the navigation program to:
determine a planned route;
obtain a real-time image and real-time positioning data that indicates a current location of the navigation system;
perform image recognition on the real-time image, and determine whether a specific object exists in the real-time image;
determine whether a route adjustment condition is met based on the planned route, the real-time positioning data and result of the determination on whether the specific object exists in the real-time image; and
adjust the planned route when the route adjustment condition is met;
wherein the route adjustment condition includes that a meaning conveyed by the specific object is in conflict with the planned route.

2. The navigation system as claimed in claim 1, wherein the processing unit determines whether the route adjustment condition is met by determining whether the meaning conveyed by the specific object includes a direction of restricted access, and determining whether the direction of restricted access is in conflict with the planned route.

3. The navigation system as claimed in claim 2, wherein the specific object is one of the following: a traffic sign a meaning conveyed by which includes a direction of restricted access, someone wearing high-visibility clothing, holding a traffic control object and making a specific gesture to control traffic, a roadblock, a traffic cone, a road-closed sign, and a barricade.

4. The navigation system as claimed in claim 2, wherein the processing unit determines whether the route adjustment condition is met by further calculating a ratio of a pixel count of the specific object in the real-time image to a total pixel count of the real-time image, and determining whether the ratio is greater than a predetermined threshold.

5. The navigation system as claimed in claim 1, wherein the storage device further stores an image recognition model, which is loaded and operated by the processing unit to perform image recognition on the real-time image to obtain an image recognition result.

6. A navigation method to be implemented by a navigation system adapted to be disposed on a vehicle, the navigation method comprising steps of:
determining a planned route;
obtaining a real-time image and real-time positioning data that indicates a current location of the navigation system;
performing image recognition on the real-time image, and determining whether a specific object exists in the real-time image;
determining whether a route adjustment condition is met based on the planned route, the positioning data and a result of the determination on whether the specific object exists in the real-time image; and
when the route adjustment condition is met, adjusting the planned route;
wherein the route adjustment condition includes that there is a conflict between the specific object and the planned route.

7. The navigation method as claimed in claim 6, wherein the step of determining whether a route adjustment condition is met includes determining whether a meaning conveyed by the specific object includes a direction of restricted access, and determining whether the direction of restricted access is in conflict with the planned route.

8. The navigation method as claimed in claim 7, wherein the step of determining whether a specific object exists in the real-time image includes identifying whether one of the following objects is in the real-time image: a traffic sign a meaning conveyed by which includes a direction of restricted access, someone wearing high-visibility clothing, holding a traffic control object and making a specific gesture to control traffic, a roadblock, a traffic cone, a road-closed sign, and a barricade.

9. The navigation method as claimed in claim 7, wherein the step of determining whether the route adjustment condition is met further includes calculating a ratio of a pixel count of the specific object in the real-time image to a total pixel count of the real-time image, and determining whether the ratio is greater than a predetermined threshold.

10. The navigation method as claimed in claim 6, wherein the step of performing image recognition on the real-time image includes inputting the real-time image into a trained image recognition model to obtain an image recognition result.
